(19) United States
(12) Patent Application Publication
(10) Pub. No.: US 2016/0004325 A1
(43) Pub. Date: Jan. 7, 2016

(54) SWIPE AND TAP KEYBOARD

(71) Applicant: ROE MOBILE DEVELOPMENT LLC, Potomac, MD (US)

(72) Inventor: Kenneth David Roe, Potomac, MD (US)

(21) Appl. No.: 14/747,326

(22) Filed: Jun. 23, 2015

Related U.S. Application Data
(60) Provisional application No. 62/016,078, filed on Jun. 23, 2014.

(51) Int. Cl. G06F 3/023; G06F 3/0488

(52) U.S. Cl. CPC G06F 3/0237; G06F 3/04883; G06F 2203/04808

(57) ABSTRACT

An electronic device having a keyboard, a text input field, a processor, a first memory, and a second memory. The keyboard includes a word completion functionality that deduces a user's word by having the user tap down on at least a first letter in the word and then identifying another letter at a predetermined position in the word. The another letter in the word is provided to the processor by at least one of (a) swiping motion from the at least first letter to the another letter, (b) holding the another letter for a predetermined amount of time, (c) holding the another letter and the at least first letter simultaneously, (d) tapping on the another letter a predetermined number of times, (e) tapping on the another letter a predetermined number of times while holding the at least first letter, and (f) pressing a first designated key that tells the processor the user is now inputting the another letter and then taping on the another letter.

### CROSS-REFERENCE TO RELATED APPLICATIONS

This application claims the benefit of provisional application Ser. No. 62/016,078, filed Jun. 23, 2014, which is relied upon and incorporated herein by reference.

### BACKGROUND OF THE INVENTION

In an effort to address the slow rate of typing with on-screen keyboards word completion functionality was developed to present a user a list of word and/or phrase choices that the user can select as a quicker alternative to completing the word or phrase letter by letter. However current word completion functionality have limited use given the large number of word choices presented and the limited screen area of hand-held devices, such as a smart phone. Additionally, alternative approaches require swiping through many letters of a word rather than just two. Accordingly, a strong need exists to improve the accuracy of word prediction and, thereby, reducing the number of word choices.

### SUMMARY OF THE INVENTION

In an embodiment of the present disclosure, an electronic device includes a keyboard, a text input field, a processor, a first memory, and a second memory. The keyboard includes a word completion functionality that deduces a user's word by having the user tap down on at least a first letter in the word and then identifying another letter at a predetermined position in the word. The another letter in the word is provided to the processor by at least one of (a) swiping motion from the at least first letter to the another letter, (b) holding the another letter for a predetermined amount of time, (c) holding the another letter and the at least first letter simultaneously, (d) tapping on the another letter a predetermined number of times, (e) tapping on the another letter a predetermined number of times while holding the at least first letter, and (f) pressing a first designated key that tells the processor the user is now inputting the another letter and then taping on the another letter.

In another embodiment, the keyboard and the text input field are on a touch screen display.

In a further embodiment, the at least first letter is the last letter entered by the user before the user insert the another letter.

In yet another embodiment, the another letter in the word is one of (i) a last letter of a non-gerund version of the word and (ii) a last letter of a singular version of the word.

In an embodiment, the another letter is a last letter in the word that does not end with at least one of the letters “e” and “s.”

In another embodiment, the predetermined position of another letter in the word is preprogrammed by the user.

In a further embodiment, the predetermined position of another letter in the word is determined by the number of taps the another letter is hit.

In yet another embodiment, the swiping motion from the at least first letter to the another letter includes tapping and holding the at least first letter and making a dragging motion to the another letter in the word.

In an embodiment, if the at least first letter in the word and the another letter in the word generate a large number of plurality of word choices, to reduce the number of plurality of word choices, at least one letter between the at least first letter and the another letter is inputted by the user and is provided to the processor.

In another embodiment, when the another letter is inserted, a list of suggested words appears for the user to choose from and be inserted in the text input field.

In a further embodiment, the list of suggested words comprises a plurality of list of suggested words, each list of the plurality of list of suggested words is accessed by the user by tapping on a predetermined button.

In yet another embodiment, the list of suggested words is in a form of a scrollable list.

In an embodiment, the list of suggested words is sortable by at least one of alphabetically and frequency used by the user.

In another embodiment, the first memory is a RAM memory and the second memory is a flash memory. The RAM memory includes at least one of a configuration program memory, a keyboard memory, and a data memory, and the flash memory includes at least one of a data memory preference, user added word and usage information, and a memory dictionary.

In a further embodiment, (1) the configuration program memory includes a program that allows the user to (a) add new words, (b) delete words, (c) review words that have been added, (d) program a short-cut for a word, (e) keep track of statistics of each word, (f) import and/or export portion or all of the list of words and phrases and their corresponding statistics, (g) program the predetermined position of the another letter, and (h) program how a list of words should be indexed and sorted; (2) the keyboard program memory stores a program to process keyboard inputs, (3) the data store stores keyboard program's data, (4) the data memory preference stores user preferences, (5) the user added word and usage information stores the user's newly added words and statistics of the newly added words, and (6) the memory dictionary stores preprogrammed words and statistics of the preprogrammed words.

In yet another embodiment, the statistics of the newly added words includes frequency usage data of each of the newly added words.

In an embodiment, the statistics of the preprogrammed words includes frequency usage data of each of the pre-programmed words.

In another embodiment, the configuration program memory includes a program that allows a user to import or export at least one of words, phrases, and their corresponding statistics.

In a further embodiment, the configuration program memory includes a program that allows the user to create a shortcut for a frequently used words and phrases.

In yet another embodiment, the configuration program memory includes a program that allows the user to preprogram the predetermined position of another letter.

In an embodiment of the present disclosure, a keyboard capable of inserting a word including a keyboard capable of providing (a) a first feedback that indicates a letter is being pressed, (b) a second feedback that indicates a user is dragging her fingers over various letters, and (c) a third feedback that indicates that the user has raised her finger.

In another embodiment, the first feedback is indicative of a first letter of a word and the third feedback is indicative of the last letter in the word.

In a further embodiment, the keyboard is capable of providing a list of possible words that start with the letter corresponding to the first feedback and ending with the letter corresponding to the third feedback.

Additional features and advantages of various embodiments will be set forth, in part, in the description that follows, and will, in part, be apparent from the description, or may be learned by the practice of various embodiments. The objectives and other advantages of various embodiments will be realized and attained by means of the elements and combinations particularly pointed out in the description herein.

### BRIEF DESCRIPTION OF THE DRAWINGS

Features of the present disclosure are illustrated by way of examples shown in the following figures. In the following figures, like numerals indicate like elements, in which

FIG. 1 is a schematic block diagram of the electronic device, according to an example of the present disclosure;

FIG. 2 is an exemplary keyboard, according to an example of the present disclosure;

FIG. 3 is the exemplary keyboard of FIG. 2, illustrating a swiping motion from the letter D to the letter G, according to an example of the present disclosure;

FIG. 4A is a flow chart of the tap and swipe method of inputting a text in a text input field, according to an example of the present disclosure;

FIG. 4B is a keyboard with a list of words form dictionary, according to an example of the present disclosure;

FIG. 5 is a flow chart of the tap and hold method of inputting a text in a text input field, according to an example of the present disclosure;

FIG. 6 is a flow chart of the simultaneous tap method of inputting a text in a text input field, according to an example of the present disclosure;

FIG. 7 is a flow chart of the multiple taping of a letter method of inputting a text in a text input field, according to an example of the present disclosure;

FIG. 8 is a flow chart of an alternative simultaneous tap method of inputting a text in a text input field, according to an example of the present disclosure;

FIG. 9A is an exemplary scrollable list of words, according to an example of the present disclosure;

FIG. 9B is an exemplary list of words with an icon indicating automatic closing of the keyboard, according to an example of the present disclosure;

FIG. 10 is a flow chart of a method for adding a new word to the user dictionary, according to an example of the present disclosure;

FIG. 11 is a keyboard with an add word key, according to an example of the present disclosure;

FIG. 12 is a flow chart of the configuration programs, according to an example of the present disclosure;

FIG. 13 is an exemplary preview page, according to an example of the present disclosure.

### DETAILED DESCRIPTION OF THE INVENTION

For simplicity and illustrative purposes, the present disclosure is described by referring mainly to examples thereof. In the following description, numerous specific details are set forth in order to provide a thorough understanding of the present disclosure. It will be readily apparent however, that the present disclosure may be practiced without limitation to these specific details. In other instances, some methods and structures have not been described in detail so as not to unnecessarily obscure the present disclosure.

Throughout the present disclosure, the terms “word” is intended to denote a single word, a hyphenated word, or a phrase. Also, the terms “word” and “phrase” are used interchangeably throughout the specification. Additionally, throughout the present disclosure, the terms “key” and button” are intended to denote an input device key or button, such as a keyboard key or keyboard button. The terms “key” and “button” are used interchangeable throughout the specification. The use of each of the terms “word” and “phrase” suggests either one. As used herein, the term “includes” means includes but not limited to, the term “including” means including but not limited to. The term “based on” means based at least in part on.

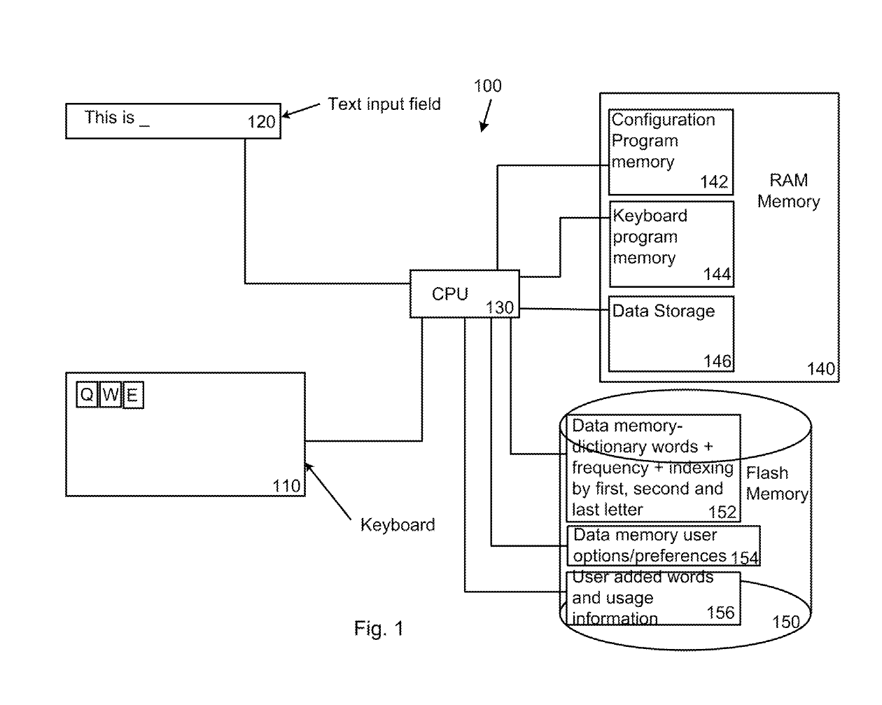

In an embodiment, as shown in FIG. 1, the present disclosure relates to an electronic device 100 having a text inputting capability involving a keyboard 110 and a word completion functionality. In one embodiment, the keyboard 110 and the word completion functionality are on a touch-sensitive display screen. In an embodiment, the keyboard 110 is a virtual keyboard.

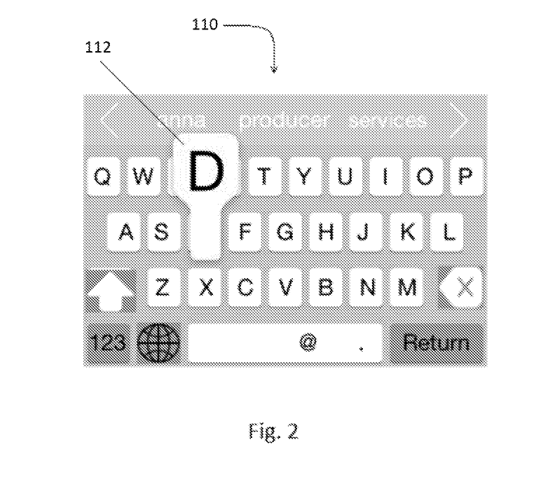

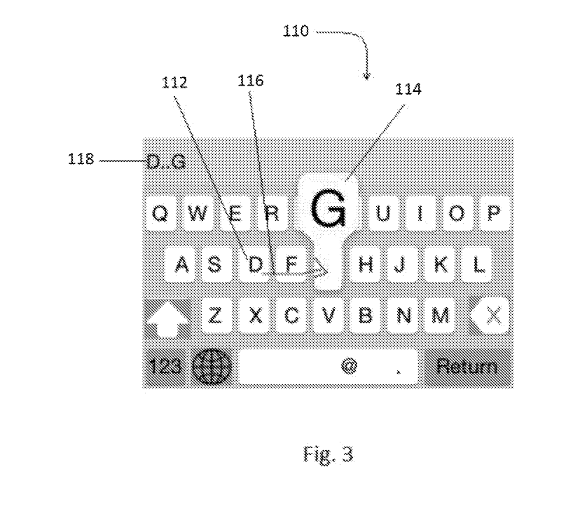

In an embodiment, the electronic device 100 may include a keyboard 110, a text input field 120, a processor 130, a first memory 140, and a second memory 150. The keyboard 110 may include a word completion functionality that may deduce a user's desired word by having the user tap down on at least a first letter 112 (see FIG. 2) in the word and then identifying another letter 114 (see FIG. 3) at a predetermined position in the word. The another letter 114 in the word may be provided to the processor 130 by at least one of (a) swiping and/or dragging motion 116 (see FIG. 3) from the at least first letter 112 to the another letter 114, (b) holding the another letter 114 for a predetermined amount of time, (c) holding the another letter 114 and the at least first letter 112 simultaneously, (d) tapping on the another letter 114 a predetermined number of times, (e) tapping on the another letter 114 a predetermined number of times while holding the at least first letter 112, and (f) pressing a first designated key (not show in the figures) that may instruct the processor 130 the user is now inputting the another letter 114.

In an embodiment, the first memory 140 may be a random access memory (RAM) and the second memory 150 may be a hard-drive or a flash drive.

The first memory 140 may include a configuration program memory 142, a keyboard memory 144, and a data store memory 146. The configuration program memory 142 may include one or more programs and/or applications that enables a user to, for example, (a) add new words and/or phrases, (b) delete words and/or phrases, (c) review words and/phrases that have been added, (d) program a short-cut for a word or a phrase, (e) keep track of statistics relating to each word or a phrase (e.g., keep track of how many times a word or a phrase has been used), (f) import and/or export portion or all of the list of words and phrases and their corresponding statistics, and (g) program the predetermined position of the another letter 114, (h) program how a list of words or phrases should be indexed and/or sorted (e.g., alphabetically or by frequency used by the user), to name a few.

In an embodiment, the keyboard program memory 144 may store a program that may process keyboard inputs. Furthermore, the data store memory 146 may store keyboard program's data.

The second memory 150 may include a data memory options or preference 152, user added word and usage information 154, and a memory dictionary 156. In one example, the data memory options or preference 152 may store user options and preferences. The user added word and usage information 154 may store the user's newly added words and/or phrases and the statistics of the corresponding added words and/or phrases. The memory dictionary 156 may store preprogrammed words and/or phrase and their corresponding statistics and indexing of the words as preprogrammed or as programmed by a user.

In an embodiment, the at least first letter 112 may be the last letter entered by the user before the user provides the another letter 114 to the processor 130. For example, a user who is trying to type the word “picture” may tap on the letters “p” “i” “c” before providing the processor 130 with the another letter “r”. In this example, the letter “c” is the at least first letter 112 and the letter “r” is the another letter 114. In another example, a user who is trying to type the word “picture” may tap on the letter “p” before providing the processor 130 with the another letter “e”. In this example, the letter “p” is the at least first letter 112 and the letter “e” is the another letter 114.

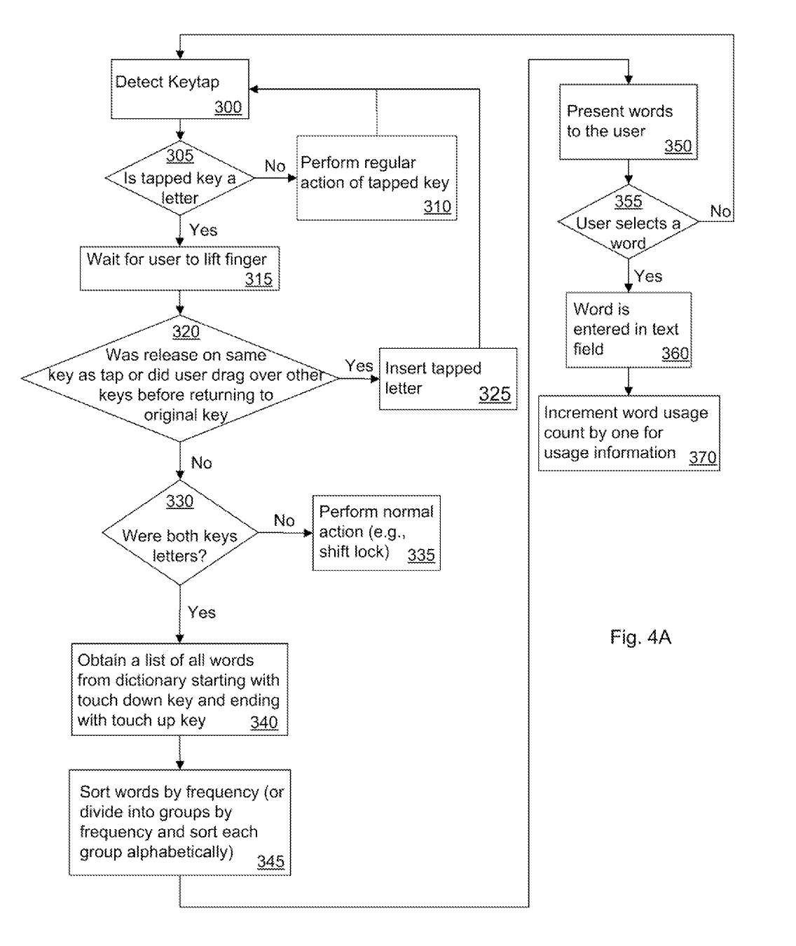

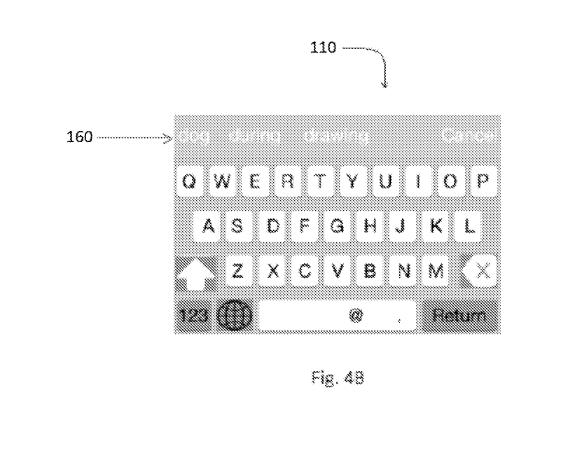

As discussed above, in one embodiment, the another letter 114 in a word may be identified and provided to the processor 130 by the swiping and/or dragging motion 116 from the at least first letter 112 to the another letter 114. In an embodiment, as illustrated in FIGS. 1 and 4A, at step 300, when a user taps a key/button on the keyboard 110, the keyboard 110 may provide a feedback to the processor 130 using its keyboard program in the keyboard program memory 144 that a key is being pressed. At step 305, the processor 130 determines if the tapped key was a letter. If the processor 130 determines that the tapped key was not a letter, at step 310, the processor 130 through the keyboard program may instruct the keyboard 110 to perform the regular action of the tapped key. However, if the processor 130 determines that the tapped key was a letter, then at step 315, the processor 130 may instruct the keyboard 110 to wait for the user to take an action, such as the user lifting his/her finger.

Once the user lifts his or her finger, the keyboard 110 may provide a feedback to the processor 130 using its keyboard program that the user has lifted his/her finger. In turn, at step 320, the processor 130 may determine if the released key (i.e., the key in which the user lifted his/her finger from) was the same as the tapped key. If the processor 130 determines that the released key was the same key as the tapped key and the user did not drag over other keys, then, at step 325, the processor 130 may instruct the keyboard to insert the tapped character. Alternatively, if the processor 130 determines that the released key was different from the tapped key or that the user dragged over other keys, then, at step 330, the processor 130 determines if the released key was a letter. If the released key was not a letter, then the processor 130 may instruct the keyboard 110 to presume its normal action instructed by the released key (e.g., shift locking the keyboard 110).

If the processor 130 determines that the released key was a letter, then the processor 130, at step 340, may instruct the memory dictionary 156 to retrieve a list of words from the dictionary, staring with the first tapped letter and containing the another letter 114 at the predetermined position in the word. At step 345, the processor 130, may also instruct the memory dictionary 156 to sort the retrieved list of words by frequency, alphabetically, frequency and alphabetically, or alphabetically and frequency. Alternatively, the processor 130, at step 345, may instruct the memory dictionary 156 to divide the retrieved list of words into groups by frequency and sort each group alphabetically. At step 350, the processor 130 may instruct the memory dictionary 156 to present the sorted and retrieved list of words to the user. The user, at step 355, may select a desired word from the sorted list of words. However, if the user is unable to find and/or see the desired word, then the actions may be canceled. After the word is entered into the text field at step 360, at step 370 the word's usage count is incremented.

In an example, a user who would like to insert the word “Dog” in the text insert field 120, first taps the first letter “D,” as shown in FIG. 2. The keyboard provides a feedback to the processor 130 that a key is being pressed. The processor 130 determines that the tapped key is the letter “D.” The user then, without lifting his or her finger, drags his or her finger to the letter “G,” which is the last letter of the word “Dog”, as shown at 116 and 114 in FIG. 3, respectively. In one embodiment, when the user drags to a letter, the keyboard gives feedback to the processor 130 as the user drags his or her finger over various letters. Also, in an embodiment, as shown at 118, in FIG. 3, just above the keyboard to the left, the electronic device 100 shows “D . . . G”, which in this particular example are the first and last letters that would be selected if the user raises his finger. However, the letters at 118 may represent the last letter or an initial group of letters entered by the user to the text input field 120 and the another letter 114, which may be at a predetermined position in the word. The predetermined position may be programmed by the user via a configuration program in the configuration program memory or may have been preprogrammed by a manufacture of the electronic device 100. In an embodiment, the letter “G” may change as the user drags his or her finger over different letters.

In an embodiment, after the user lifts his or her finger, a list of possible words as well as a “cancel” button to cancel the entry may appear on a portion of the touch-sensitive display screen. For example, the list of possible words as well as a “cancel” button may appear above the keyboard 101, as shown at 160 in FIG. 4A.

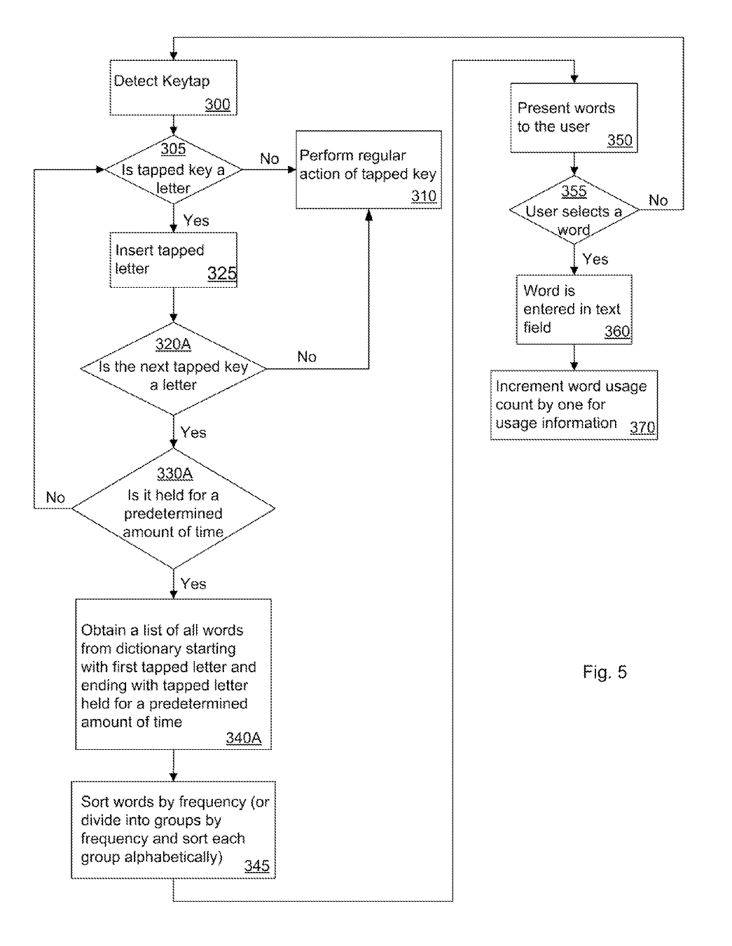

In another embodiment, as shown in FIG. 5, instead of the user dragging his or finger from the at least first letter 112 to the another letter 114, the user may identify and provide the another letter 114 to the processor 130 by holding the another letter 114 for a predetermined amount of time, such as from about 1 second or less to about 10 seconds or more, such as from about 1 second to about 5 seconds, for example from about 1 second to about 3 seconds, such as about 2 seconds. In this embodiment, the steps 300, 305, and 310 are identical to the embodiment of FIG. 4A.

In this embodiment, if the processor 130 determines that the tapped key was a letter, then the tapped letter is inserted at step 325. Once a second key is tapped, at step 320A, the processor 130 determines if the tapped key was a letter. If the processor 130 determines that the tapped key was not a letter, at step 310, the processor 130 through the keyboard program may instruct the keyboard 110 to perform the regular action of the tapped key. However, if the processor 130 determines that the tapped key was a letter, then, at step 330A, the keyboard 110 may provide a feedback to the processor 130 using its keyboard program as to how long the tapped letter was pressed. The processor 130 then determines if the amount of time in which the tapped letter was pressed was more than the preprogrammed predetermined time or less than the preprogrammed determined time.

If the amount of time in which the tapped letter was pressed is less than the preprogrammed predetermined time, then the tapped letter of step 330A is inserted as the next letter in the word at step 325. However, if the amount of time in which the tapped letter was pressed is more than the preprogrammed predetermined time, then the processor 130 determines that this tapped letter is the another letter 114 (referring to FIG. 3). In this case, the processor 130, at step 340A, may instruct the memory dictionary 156 to retrieve a list of words from the dictionary, staring with the first tapped letter and containing the another letter 114 at the predetermined position in the words (e.g., the last letter). The remaining steps 345-370 are identical to the embodiment of FIG. 4A.

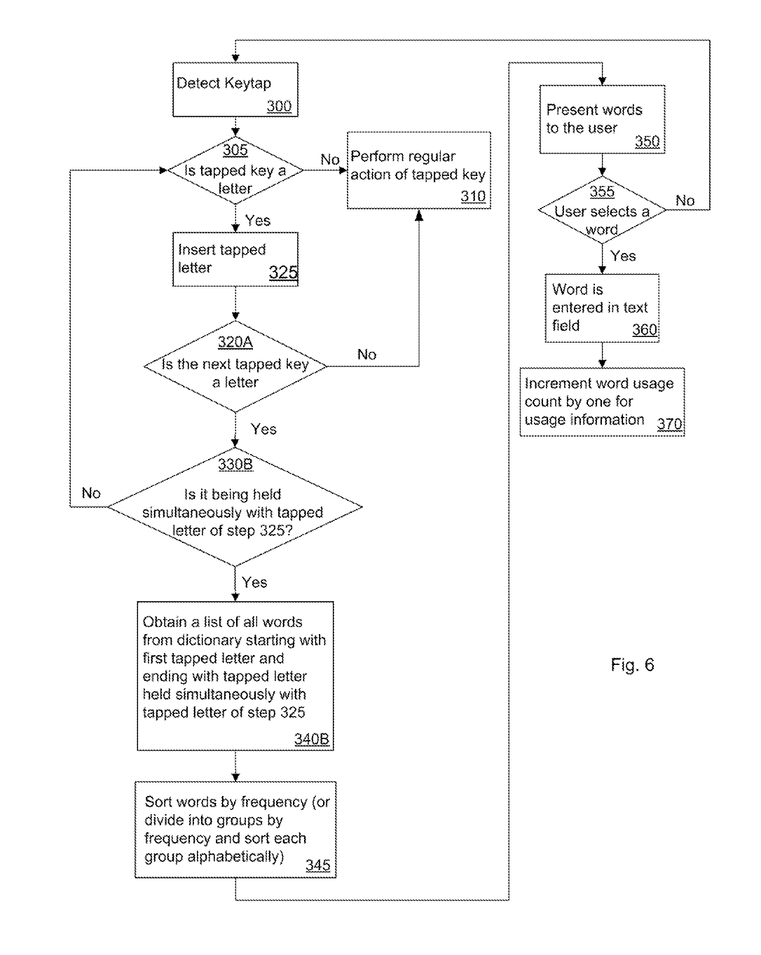

In another embodiment, as shown in FIG. 6, instead of the user holding the another letter 114 for a predetermined amount of time, the user may identify and provide the another letter 114 to the processor 130 by simultaneously holding the at least first letter 112 and the another letter 114. In this embodiment, steps 300, 305, 310, 320A, and 325 are identical to the embodiment of FIG. 5.

At step 320A, if the processor 130 determines that the tapped key was a letter, then, at step 330B, the keyboard 110 may provide a feedback to the processor 130 using its keyboard program to determine if the tapped letter is being held simultaneously with the tapped letter of step 325. If the tapped letter is not being held simultaneously with the tapped letter of step 325, then the tapped letter of step 330B is inserted as the next letter in the word at step 325. However, if the processor determines that the tapped letter in step 330B is being held simultaneously with the tapped letter of step 325, then the processor 130 determines that this tapped letter is the another letter 114 (referring to FIG. 3). In this case, the processor 130, at step 340B, may instruct the memory dictionary 156 to retrieve a list of words from the dictionary, staring with the first tapped letter and containing the another letter 114 at the predetermined position in the words (e.g., the last letter). The remaining steps 345-370 are identical to the embodiment of FIG. 5.

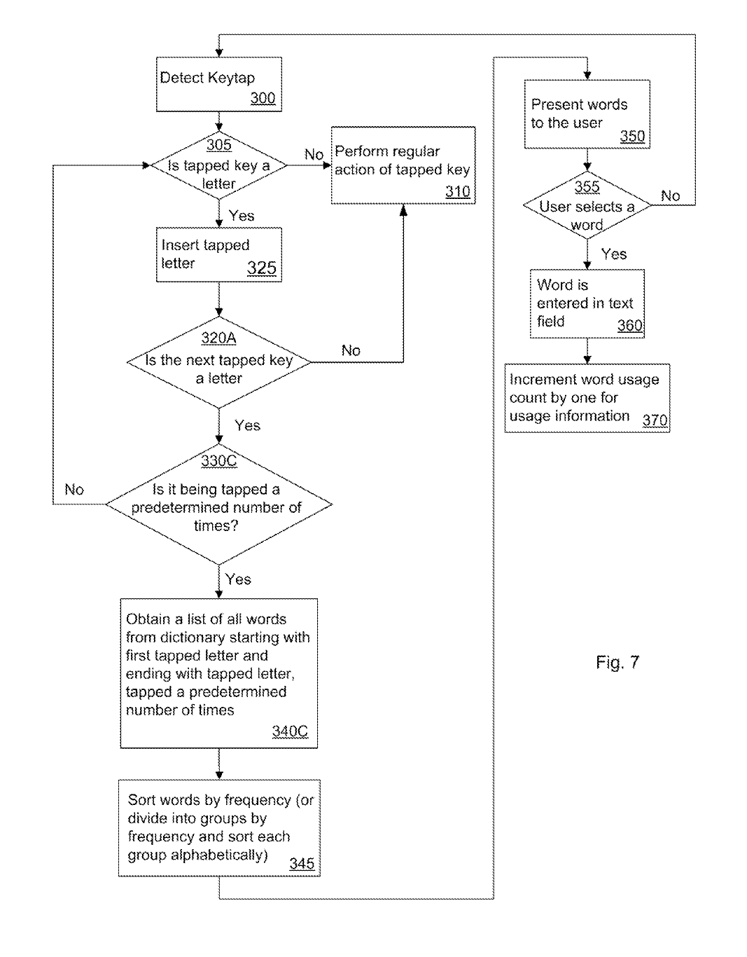

In another embodiment, as shown in FIG. 7, instead of the user simultaneously holding the at least first letter 112 and the another letter 114, the user may identify and provide the another letter 114 to the processor 130 by tapping the another letter 114 a plurality of times, such as at least two times to 10 times or more, such as at least three times to 5 times, for example 4 times. In this embodiment, steps 300, 305, 310, 320A, and 325 are identical to the embodiment of FIG. 6.

At step 320A, if the processor 130 determines that the tapped key was a letter, then, at step 330C, the keyboard 110 may provide a feedback to the processor 130 using its keyboard program to determine if the tapped letter is being tapped a predetermined number of times, such as at least 2 times. If the tapped letter is not being tapped a predetermine number of times, then then tapped letter of step 330C is inserted as the next letter in the word at step 325. However, if the processor 130 determines that the tapped letter in step 330C is being tapped a predetermine number of times, then the processor 130 determines that this tapped letter is the another letter 114 (referring to FIG. 3). In this case, the processor 130, at step 340C, may instruct the memory dictionary 156 to retrieve a list of words from the dictionary, staring with the first tapped letter and containing the another letter 114 at the predetermined position in the words (e.g., the last letter). In an embodiment, the position of the another letter 114 is determined by the number of times the another letter 114 has been tapped. For example, if a user want to insert the word “picture’ in the text input field 120, the user can enter the letter “p” and then tap the letter “t” four times indicating that the letter “t” is the another letter 114 and its position is the fourth letter in the word. The remaining steps 345-370 are identical to the embodiment of FIG. 6.

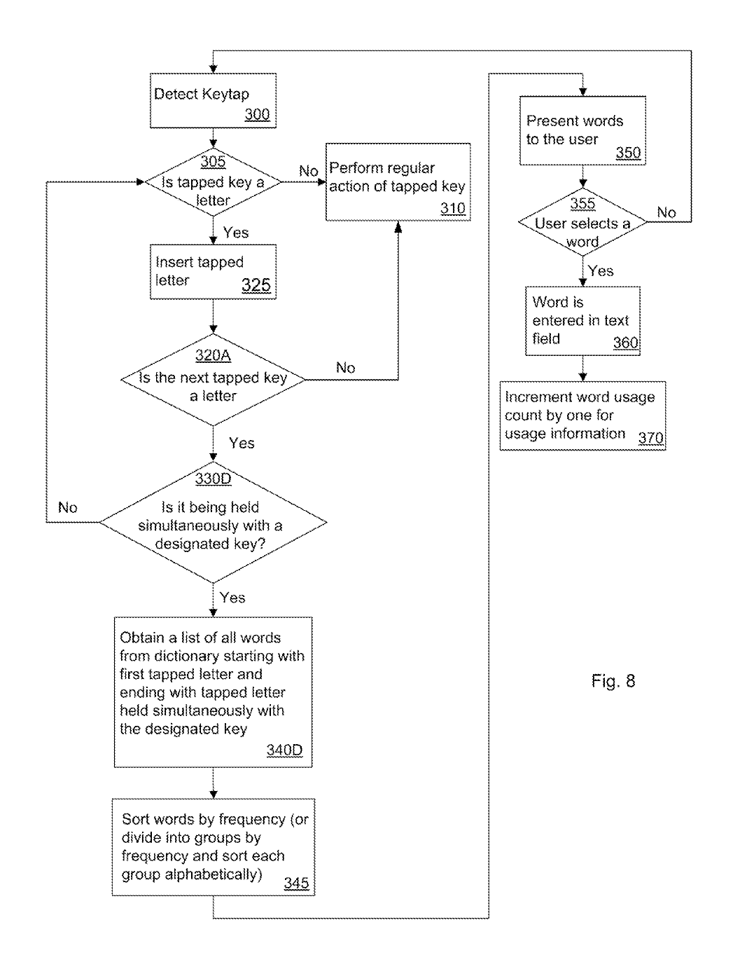

In another embodiment, as shown in FIG. 8, instead of the user simultaneously holding the at least first letter 112 and the another letter 114, the user may identify and provide the another letter 114 to the processor 130 by simultaneously holding a designated key (not shown in the figures) and the another letter 114. In this embodiment, steps 300, 305, 310, 320A, and 325 are identical to the embodiment of FIG. 6.

At step 320A, if the processor 130 determines that the tapped key was a letter, then, at step 330D, the keyboard 110 may provide a feedback to the processor 130 using its keyboard program to determine if the tapped letter is being held simultaneously with a designated key, which identifies the letter as being the another letter 114. If the tapped letter is not being held simultaneously with the designated key, then the tapped letter of step 330D is inserted as the next letter in the word at step 325. However, if the processor 130 determines that the tapped letter in step 330D is being held simultaneously with the designated key, then the processor 130 determines that this tapped letter is the another letter 114 (referring to FIG. 3). In this case, the processor 130, at step 340D, may instruct the memory dictionary 156 to retrieve a list of words from the dictionary, staring with the first tapped letter and containing the another letter 114 at the predetermined position in the words (e.g., the last letter). The remaining steps 345-370 are identical to the embodiment of FIG. 6.

In each of the embodiments above, the dragging, tapping, or tapping and holding motion may suggest the second letter instead of the last letter of the word. This may be especially helpful for words that end with the letter ‘e.’

In yet another alternative embodiment, the dragging, tapping, or tapping and holding motion may suggest the last letter of the word. However, if there are too many suggested words, the user may continue typing the letter between the first and the last letter of the word to reduce the number of suggested words.

In yet another alternative embodiment, the user may program the keyboard so that the dragging, tapping, or tapping and holding motion suggests a letter from the second letter to the last letter of the desired word.

In an embodiment, the another letter 114 in a word is the last letter of a non-gerund version of the word. For example, if a user wants to insert the word “pointing,” the user would insert the letter “p” as the first letter and the letter “t” as the fifth letter and/or ending letter (depending on the user's preference). The processor 130 would then request the data memory dictionary 156 to retrieve a list of words starting with the letter “p” and ending with the letter “t.” In one embodiment, the list of words would include the gerund and plural versions of the words that start with the letter “p” and having a fifth letter and/or an ending letter as “t”. In this particular embodiment, when the program requires the fifth letter to be the letter “t”, then the list of words would include words such as “point,” “points,” “pointing,” “pointable,” “pointillism,” “point-of-care,” “pointer,” “pointless,” “pointman,” and “pointy.” However, when the program requires the last letter to be the letter “t” then the words such as “pointillism” and “pointman” would not appear in the list of words.

In another embodiment, the application may be programmed to only show the plane version of each word, (i.e., the list of words would not include the gerund, plural, or derivative) versions of the words that start with the letter “p” and end with the letter as “t”. In this embodiment, once the user selects a desired word (e.g., point) from the list of words, a second list may appear that would include the desired word's gerund, plural, and derivatives. For example, the second optional list would include words such as “points,” “pointing,” “pointable,” “pointer,” “pointless,” “pointman,” and “pointy.”

In another embodiment, the another letter 114 in a word is the last letter of a singular version of the word. In yet another embodiment, if a word ends with the letters “e” or “s”, the another letter 114 is the last letter before the appearance of the ending letter “e” or “s”.

In an embodiment, the predetermined position of the another letter 114 in a word is preprogrammed by the user. In this embodiment, the user may utilize a program or an application stored in the configuration program memory 142 to preprogram the position of the another letter 114 in a word. For example, the user can designate the position of the another letter 114 to be the 4^{th} letter in any word.

In an embodiment, the predetermined position of the another letter 114 is a word is determined by the number of times the another letter 114 has been tapped. For example, if a user want to insert the word “picture’ in the text input field 120, the user can enter the letter “p” and then tap the letter “t” four times indicating that the letter “t” is the another letter 114 and its position is the fourth letter in the word.

In an embodiment, above the keyboard 110 or the top portion of the keyboard 110 may include a list of “suggested next words.” If the first set of suggested words does not include the intended or desired word, a user may click on the “suggested next words” button to view the next set of suggested words.

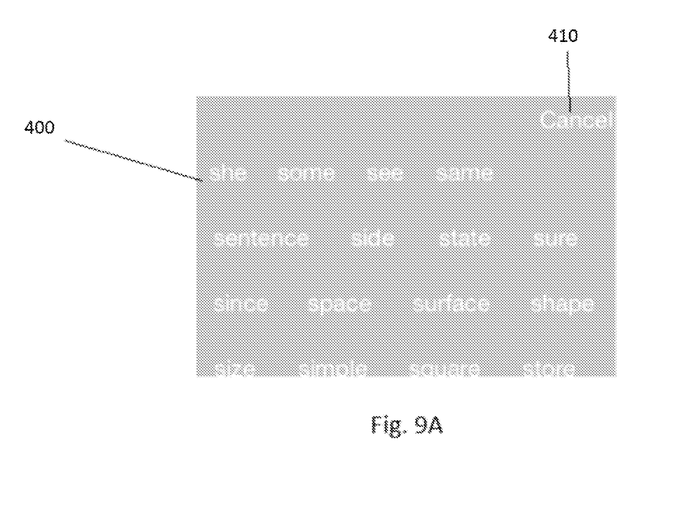

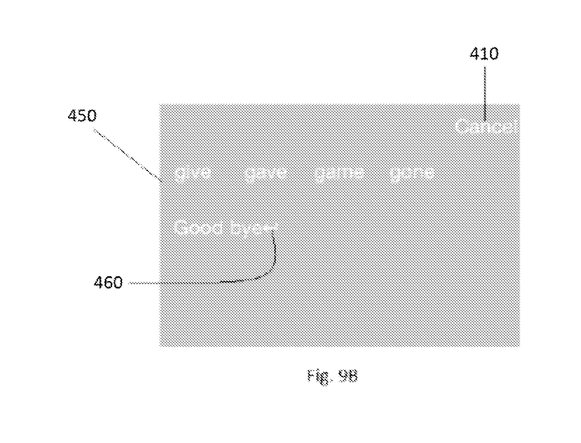

In an embodiment, when the list of words is large, the keyboard 110 may be replaced with a scrollable list of words 400, as shown in FIG. 9A. The scrollable list of words 400 may include a cancel button so that the user can go back to the original keyboard 110. In an embodiment, when the desired word is selected, it is entered into the text input field 120 and the keyboard 110 returns.

In an embodiment, as shown in FIG. 9B, the list of words 450 may include an icon 460 indicating automatic closing of the keyboard. For example, in this embodiment, if the user selects the word “Good by [symbol] ”, it is entered and the keyboard automatically closes.

As an alternative to the scrollable list, a menu driven interface may be implemented to pick out additional characters in the word (or to sort them by frequency or alphabetically). Also, the list of words may be improved by highlighting the most frequently used words to make them easier to spot. Alternatively, as described above, the last letter may be designated as the last letter by holding the last letter key for a predetermined amount of time (for example 3 seconds). In this alternative embodiment, the user can type the first few letters and then the last letter to reduce the number of word options.

In an embodiment, the user can simply ignore the suggestions and simply continue typing the word in its entirety, similar to using a regular or virtual existing keyboards.

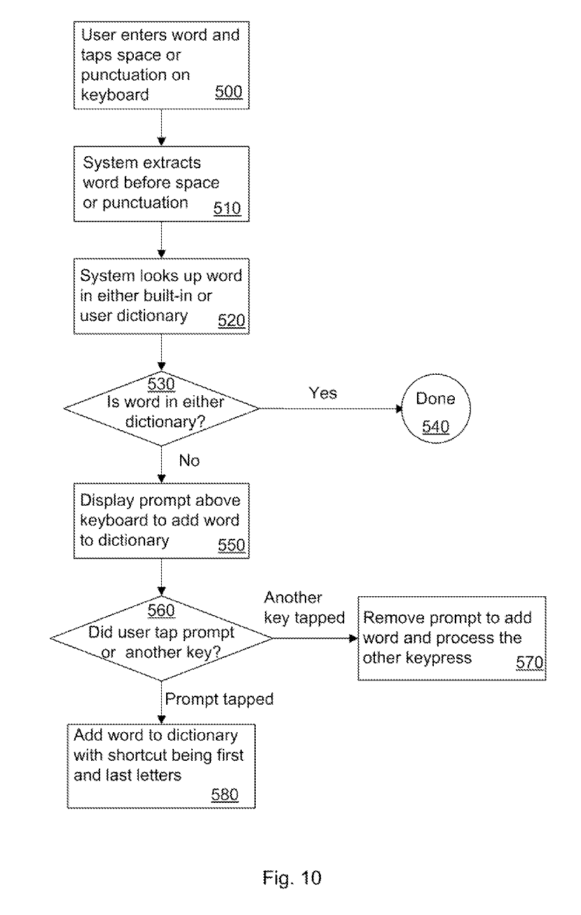

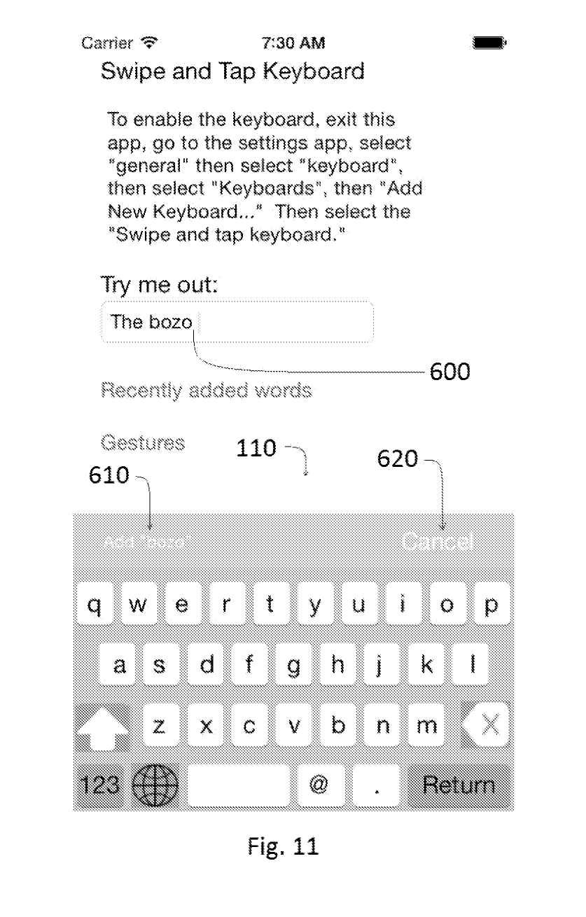

If a word is not in the dictionary, then the user can add the word. The steps for adding a new word to the user dictionary are described in FIG. 10. At step 500, a user enters the word and press space (as shown at 600, in FIG. 11) or another non-letter character, such as a punctuation, so the word is known to be complete. At step 510, a program or application located in the configuration program memory 142 (FIG. 1), may extract the word before space or another non-letter character. At step 520, the program or application informs the processor 130 regarding the word. The processor in turn, looks up the word in at least one of the built-in dictionary or the user dictionary located in memory dictionary 156 or the user added words and usage information 154, respectively. At step 530, the processor 130 determines if the word is in either of the built-in or user dictionaries. If the word is in either of the two dictionaries, the process is completed at step 540 and the word does not need to be added to the user dictionary. However, if the word is not in either of the two dictionaries, the processor 130, at step 550, commands the keyboard 110 to display a prompt above the keyboard 110 to add the word to the user dictionary.

An exemplary prompt is shown at 610, in FIG. 11. At step 560, the user makes a decision whether to tap prompt 610 or press another key, such as an optional cancel key 620 or a letter on the keyboard. If the user elects to press another key, such as the optional cancel key 620, at step 570, the prompt is removed and the processor 130 processes the command of the another key. However, if the user elects to tap the prompt key 610, then, at step 580, the word is added to the user dictionary.

In an embodiment, a short cut is automatically created. In an embodiment the shortcut to the word may be the first and the last letters of the word. In another embodiment, the user may program the electronic device 100 so that the user can select his or her own shortcut to the word. For example, the use can program the electronic device, such that when the word is added to the user dictionary in step 580, the program asks the user “do you want to create a short cut for this word?” If the user elects to create a shortcut, he or she can tap on yes and then the program will ask the user to “please type a shortcut for the word in the box.” In response, the user can type, for example, “BZ” as a shortcut to the word “Bozo.”

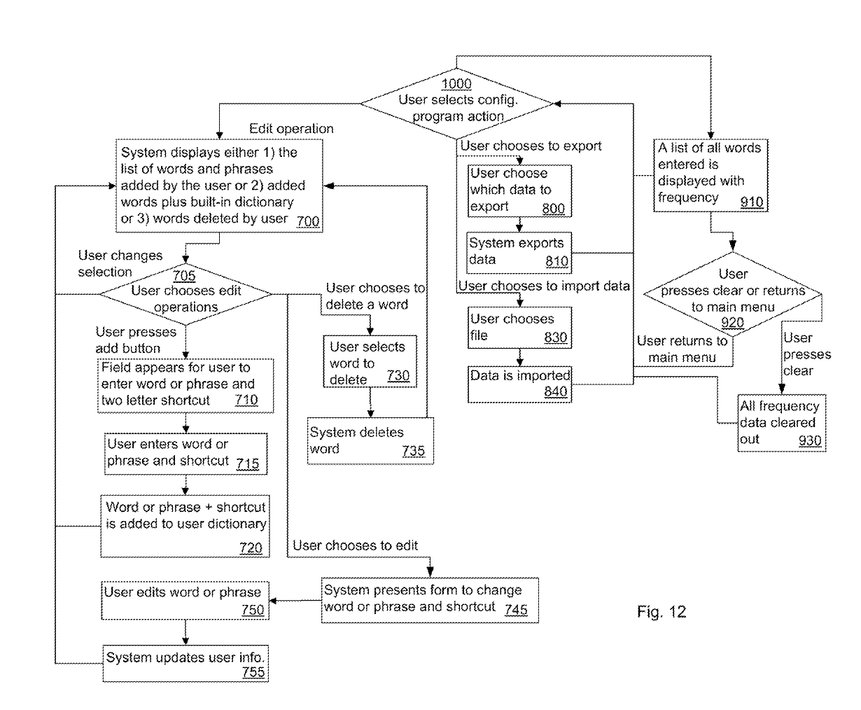

In an embodiment, the configuration program memory 142 may include one or more programs and/or applications to performs functions such as (a) editing operations, at step 700, such as displaying list of words and phrases added by the user, displaying the new added words and the built-in dictionary, and displaying words deleted by the user, (b) exporting operations, at step 800, such as exporting different data, for example exporting words and statistics corresponding to each word (c) importing operations, at step 830, such as importing different data, for example importing dictionary, and (d) displaying word frequency data. A flow chart of such exemplary programs is illustrated in FIG. 12.

As stated above, the editing operations 700 may include displaying list of words and phrases added by the user, displaying the new added words and the built-in dictionary, and displaying words deleted by the user. Additionally, the user may add a word/shortcut, edit a word/shortcut, delete a word/shortcut, and change which of the three options from above is displayed. At step 705, a user may choose an editing operation, such as adding a word, deleting a word, or editing a word. In an embodiment, when the user decides to add a word, the user can tap on the add button. At step 710, a field appears for the user to enter the word and/or phrase and a corresponding shortcut. In step 715, the user fills-in the fields by entering the word and/phrase and the corresponding desired shortcut, which may be two letters. Once the fields have been completed, in step 720, the word and/or phrase and the shortcut is added to the user dictionary. The details of how a new word is added to the user dictionary and creating a shortcut for the added word is also described above, with respect to FIGS. 10 and 11.

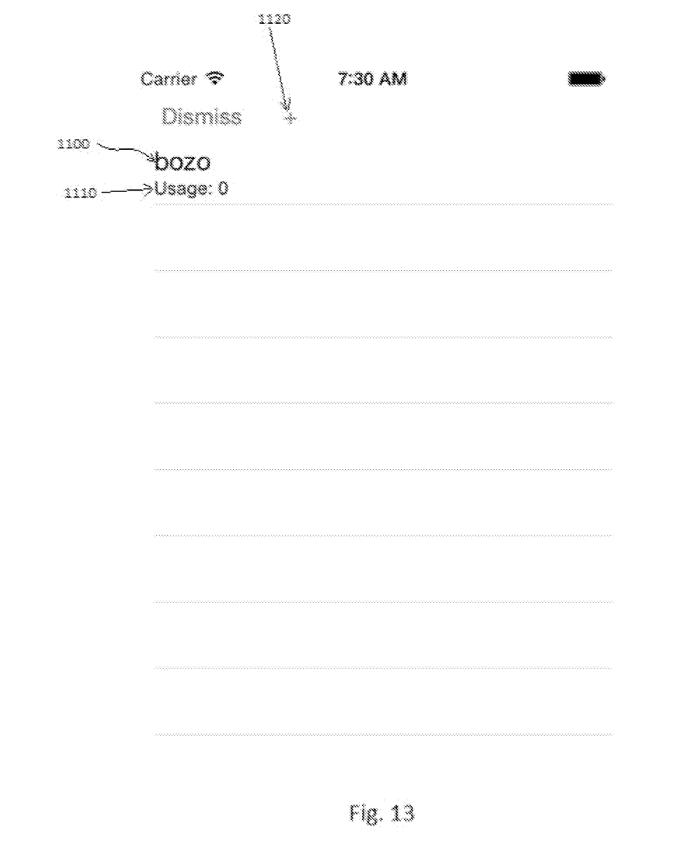

In an embodiment, configuration program may include a program that, among other things, allows a user to review words that have been added. An exemplary review page is illustrated in FIG. 13. As shown in FIG. 13, the review page shows the list of added words, at 1100, and how many times each added word has been used, at 1110. If a word is not being used often, then the user can delete it by left swiping the entry. Alternatively, the “+” button, shown at 1120 at the top can be used to add more words.

As stated above, at step 705, a user may choose an editing operation, such as adding a word, deleting a word, or editing a word. In an embodiment, when the user decides to delete a word, the user may, at step 730, may select one or more words to delete from a list of words, such as the list of words shown in FIG. 13. In one example, if a word, such as word 1100 in FIG. 13, is not being used often (usage of 0, as shown at 1110), the user may delete it by left swiping the entry. Left swiping may include tapping and holding the entry and quickly dragging to the left. In step 735, the user may choose to delete a word from the list of words. However, the word is not directly deleted from that dictionary. Instead, it is added to a list of “deleted words.” This list of “deleted words” receives words that are deleted from both the built-in dictionary located in the memory dictionary 156 and from the user dictionary located in the user added word and usage information 154. After completion of step 735, the electronic device 100 will take the user back to the edit operation 700.

As stated above, at step 705, a user may choose an editing operation, such as adding a word, deleting a word, or editing a word. In an embodiment, when the user decides to edit a word, at step 745, a form is displayed, which shows the current words and their corresponding shortcuts. This form allows the user to edit each of the words and/or their corresponding shortcuts. At step 750, the user completes the editing and taps on the “Done” button. At step 755, the program updates the edited words and/or their corresponding shortcuts.

As stated above, the configuration program memory 142 may include a program for exporting data. When a user decides to export data, at step 800, the user can select which data to export. For example the user can select to export all words with non-zero frequency usage or any subset thereof. Alternatively, the user can select words and/or their corresponding shortcuts and their corresponding statistics to be exported. At step 810, the data may be exported in the form of an XML file with the words, the two letter shortcut for each corresponding word, and optionally, usage frequency of each of the words. In an example the export page may provide a set of options of what to export. Some exemplary options include, but are not limited to, all added words/shortcuts and usage information and all added words/shortcuts without usage information. There may be options for subsets of the added words, for example, there may be an export option for 100 most recent words without usage information.

As stated above, the configuration program memory 142 may include a program for importing data. When a user decides to import data, at step 830, the user may select a file. Generally, the step of selecting a file is done by another application, which may send the file to the keyboard configuration application. Once the file has been selected, at step 840, the data in the file is imported and added to the user dictionary.

As stated above, the configuration program memory 142 may include a program for displaying word frequency data. In one embodiment, there are two sets of frequency data. The first set is for the built-in dictionary and may be generated from a database when the program was developed. The second set keeps track of the number of times a user uses each word. It is this second set of data that can be cleared out. A user when selecting to view the word frequency data, at step 910, a program displays a list of all words entered with their corresponding frequency. The displayed list of words may include words in both the user dictionary and the built-in dictionary that the user has entered, with their corresponding shortcuts, along with the number of times that each word has been entered in the text input field 120 using the shortcut. Alternatively, the list may count the number of times a word is entered either with or without the shortcut. After reviewing the list, at step 920, the user has the option of either clearing the number of times a user has used each word (i.e., the frequency data) or return to the main menu. If the user decides to clear the frequency data, the user can press on the clear button, which in turn, at step 930, will clear all of the frequency data. Alternatively, the user may return to the main menu by pressing on a main menu button.

While the foregoing written description of the invention enables one of ordinary skill to make and use what is considered presently to be the best mode thereof, those of ordinary skill will understand and appreciate the existence of variations, combinations, and equivalents of the specific embodiment, method, and examples herein. The invention should therefore not be limited by the above described embodiment, method, and examples, but by all embodiments and methods within the scope and spirit of the invention.

What is claimed is:

1. An electronic device comprising:
a keyboard;
a text input field;
a processor;
a first memory; and
a second memory,
wherein the keyboard includes a word completion functionality that deduces a user's word by having the user tap down on at least a first letter in the word and then identifying another letter at a predetermined position in the word, and wherein the another letter in the word is provided to the processor by at least one of (a) swiping motion from the at least first letter to the another letter, (b) holding the another letter for a predetermined amount of time, (c) holding the another letter and the at least first letter simultaneously, (d) tapping on the another letter a predetermined number of times, (e) tapping on the another letter a predetermined number of times while holding the at least first letter, and (f) pressing a first designated key that tells the processor the user is now inputting the another letter and then taping on the another letter.

2. The electronic device of claim 1, wherein the keyboard and the text input field are on a touch-sensitive display screen.

3. The electronic device of claim 1, wherein the at least first letter is the last letter entered by the user before the user provides the another letter to the processor.

4. The electronic device of claim 1, wherein the another letter in the word is one of (i) a last letter of a non-gerund version of the word and (ii) a last letter of a singular version of the word.

5. The electronic device of claim 1, wherein the another letter is the last letter before the “e” or “s” ending of the word.

6. The electronic device of claim 1, wherein the predetermined position of the another letter in the word is preprogrammed by the user.

7. The electronic device of claim 1, wherein the predetermined position of the another letter in the word is determined by the number of times the another letter has been tapped.

8. The electronic device of claim 1, wherein the swiping motion from the at least first letter to the another letter includes tapping and holding the at least first letter and making a dragging motion to the another letter in the word.

9. The electronic device of claim 1, wherein if the at least first letter in the word and the another letter in the word generate a large number of plurality of word choices, to reduce the number of plurality of word choices, at least one letter between the at least first letter and the another letter is inputted by the user and is provided to the processor.

10. The electronic device of claim 1, wherein when the another letter is in the word is provided to the processor, a list of suggested words appears for the user to choose from and be inserted in the text input field.

11. The electronic device of claim 10, wherein the list of suggested words comprises a plurality of list of suggested words, each list of the plurality of list of suggested words is accessed by the user by tapping on a predetermined button.

12. The electronic device of claim 10, wherein the list of suggested words is in a form of a scrollable list.

13. The electronic device of claim 10, wherein the list of suggested words is sortable by at least one of alphabetically and frequency used by the user.

14. The electronic device of claim 1, wherein the first memory is a RAM memory and the second memory is a flash memory,
wherein the RAM memory comprises at least one of a configuration program memory, a keyboard memory, and a data memory, and
wherein the flash memory comprise at least one of a data memory preference, user added word and usage information, and a memory dictionary.

15. The electronic device of claim 14, wherein the configuration program memory comprises at least a program that allows the user to perform at least one of the following functions:
(a) add new words,
(b) delete words,
(c) review words that have been added,
(d) program a short-cut for a word,
(e) keep track of statistics of each word,
(f) import and/or export portion or all of the list of words and phrases and their corresponding statistics,
(g) program the predetermined position of the another letter, and
(h) program how a list of words should be indexed and sorted;
wherein the keyboard program memory stores a program that processes keyboard inputs;
wherein the data store memory stores keyboard program's data,
wherein the data memory preference stores user preferences,
wherein the user added word and usage information stores the user's newly added words and statistics of the newly added words, and
wherein the memory dictionary stores preprogrammed words and statistics of the preprogrammed words.

16. The electronic device of claim 15, wherein the statistics of the newly added words comprises frequency usage data of each of the newly added words.

17. The electronic device of claim 15, wherein the statistics of the preprogrammed words comprises frequency usage data of each of the pre-programmed words.

18. Keyboard capable of inserting a word comprising:
a keyboard that provides:
a first feedback that indicates a letter is being pressed;
a second feedback that indicates a user is dragging her fingers over various letters; and
a third feedback that indicates that the user has raised her finger.

19. The keyboard of claim 18, wherein the first feedback is indicative of a first letter of a word and the third feedback is indicative of the last letter in the word.

20. The keyboard of claim 18, wherein the keyboard is capable of providing a list of possible words that start with the letter corresponding to the first feedback and ending with the letter corresponding to the third feedback.
